(19) United States
(12) Patent Application Publication
(10) Pub. No.: US 2018/0168382 A1
(43) Pub. Date: Jun. 21, 2018

(54) Cubicle Privacy Curtain Assembly

(71) Applicant: Karen Goelst, Sausalito, CA (US)

(72) Inventor: Karen Goelst, Sausalito, CA (US)

(21) Appl. No.: 15/253,207

(22) Filed: Aug. 31, 2016

(51) Int. Cl. A47H 21/00; A47H 1/04; A47H 13/01; A47H 23/08; G04F 1/00; G06K 7/14; G06K 7/10

(52) U.S. Cl. CPC A47H 21/00; A47H 1/04; A47H 13/01; A47H 23/08; A47H 2201/02; G06K 7/1413; G06K 7/1417; G06K 7/10366; G04F 1/00

(57) ABSTRACT

A cubicle privacy curtain assembly for use with an overhead curtain track includes a main portion having opposed upstanding leading and trailing edges with opposed top and bottom edges extending between the leading and trailing edges, respectively, such that the edges collectively define a flexible curtain sheet. Spaced apart track fasteners extend upwardly to selectively engage with the curtain track. A flexible protective panel is removably coupled to the curtain main portion along the leading edge, the protective panel having a front section and a rear section connected to the front section in a unitary construction, the front section being selectively foldable toward the rear section along an upstanding center line of weakness such that the front and rear sections of the protective panel are selectively positioned on the front and back sides of the curtain sheet, respectively, with the leading edge in contact with the center line of weakness.

### BACKGROUND OF THE INVENTION

This invention relates generally to cubicle privacy curtains and, more particularly, to a cubicle privacy curtain assembly having a protective panel removal mounted to a leading edge of the curtain. Further, the cubicle privacy curtain assembly includes a timer device that indicates when the protective panel needs to be replaced and having an electronic data collection member for tracking identifying data relative to the curtain assembly.

Healthcare cubicle curtains are constructed of Polypropylene (PP) non-woven fabric dividers that are often hung from a track assembly in a patient room or emergency room for the main purpose of providing privacy to a patient during or waiting for medical treatment. The cubicle curtains are typically mounted slidably to the track assembly so that they can be quickly opened and closed by medical staff. The leading edge of a medical divider curtain is the most touched item in a patient's room yet is rarely cleaned.

Unfortunately, the frequent touching and sometimes hasty grabbing by medical personnel leads to the leading edge of the curtain becomes dirty, infected with germs, and is a haven for substances potentially causing medical problems to the patient. For instance, a doctor or nurse may have blood, medical waste, or other unclean substances on his or her gloves as contact is made with the leading edge of the curtains. Over time, the accumulation of such material may result in the entire curtain assembly needing to be replaced.

Cubicle curtains are often not cleaned or changed with optimal frequency. There are various reasons for this lack of cleaning or replacement, including that it is labor intensive to replace a complete curtain assembly, the large panels of a curtain assembly are difficult to manage, non-standard curtain panels which makes replacement difficult, little or no documentation regarding prior replacements, and the need to quickly turn over patient rooms for the next patient.

Therefore, it would be desirable to have a cubicle curtain assembly that includes a protective panel removably coupled to a leading edge of the curtain that is quickly and easily replaceable when it becomes dirty or just worn out. Further, it would be desirable to have a medical curtain assembly that includes integrated mounting fasteners that are quickly and easily coupled to the curtain track of a hospital room. In addition, it would be desirable to have a medical curtain assembly having an attached timer device that visually indicates when the replaceable protective panel needs to be replaced. Further still, it would be desirable to have a medical curtain assembly having an electronic data collection device containing data that identifies the curtain Protocol and may be correlated with other data regarding a patient room, protective panel Protocol replacement, and the like.

### SUMMARY OF THE INVENTION

A cubicle privacy curtain assembly for use with an overhead curtain track according to the present invention includes a curtain main portion having an upstanding leading edge and a trailing edge opposed from said leading edge, said main portion having opposed top and bottom edges extending between the leading and trailing edges, respectively, such that the edges collectively define a flexible curtain sheet having front and back sides. A plurality of spaced apart track fasteners extends upwardly to selectively operative engage with the curtain track. A flexible protective panel is removably coupled to the curtain main portion along the leading edge, the protective panel having a front section and a rear section connected to the front section in a unitary construction, the front section being selectively foldable toward the rear section along an upstanding center line of weakness such that the front and rear sections of the protective panel are selectively positioned on the front and back sides of the curtain sheet, respectively, with the leading edge in contact with the center line of weakness.

Therefore, a general object of this invention is to provide a cubicle privacy curtain assembly having a removable and replaceable protective panel mounted along a leading edge of the curtain.

Another object of this invention is to provide a cubicle privacy curtain assembly, as aforesaid, in which the protective panel includes a timer device that visually indicates when the panel should be removed and replaced.

A further object of this invention is to provide a cubicle privacy curtain assembly, as aforesaid, having integrated fasteners that are quickly and efficiently coupled to an overhead curtain track.

A still further object of this invention is to provide a cubicle privacy curtain assembly, as aforesaid, having a data collection device (RFID or NFC chip) mounted to the curtain that includes encoded data regarding a curtain identifier, curtain location data, protective panel replacement data, or the like that may be read and processed by a corresponding data reading device.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1a is a perspective view of a cubicle privacy curtain assembly according to a preferred embodiment of the present invention;

FIG. 1b is a front view of the curtain assembly as in FIG. 1a;

FIG. 1c is an isolated view on an enlarged scale taken from FIG. 1a;

FIG. 1d is an isolated view on an enlarged scale taken from FIG. 1a;

FIG. 1e is an isolated view on an enlarged scale taken from FIG. 1a;

FIG. 2a is a perspective view of the curtain assembly having an alternative structure for mounting to an overhead track;

FIG. 2b is a front view of the curtain assembly as in FIG. 2a;

FIG. 2c is an isolated view on an enlarged scale taken from FIG. 2b;

FIG. 3a is a perspective view of the curtain assembly as in FIG. 1a illustrated with the protective panel removed;

FIG. 3b is a front view of the curtain assembly as in FIG. 3a;

FIG. 4a is a front view of a data reading device according to an aspect of the present invention;

FIG. 4b is a perspective view of the data reading device as in FIG. 4a;

FIG. 5a is a front view of a data reading device in the form of a smart phone;

FIG. 5b is a perspective view of the data reading device as in FIG. 5a;

FIG. 6 is a mobile computing device, such as a tablet, having a camera and configured to operate as a data reading device;

FIG. 7a is a rear view of a protective panel illustrating the surface that are then mounted to the faces of the main curtain portion of the curtain assembly;

FIG. 7b is a perspective view of the protective panel as in FIG. 7a;

FIG. 8a is a perspective view of the protective panel in a folded configuration;

FIG. 8b is a front view of the folded panel as in FIG. 8a;

FIG. 8c is a sectional view taken along line 8c-8c of FIG. 8b;

FIG. 8d is an isolated view on an enlarged scale taken from FIG. 8c;

FIG. 9a is a perspective view of an “Integrated Glide” mounting fastener separated from the curtain main portion of FIG. 1a;

FIG. 9b is a front view of the mounting fastener as in FIG. 9a;

FIG. 10a is another front view of the mounting fastener of FIG. 9b;

FIG. 10b is a sectional view taken along line 10b-10b of FIG. 10a;

FIG. 10c is an isolated view on an enlarged scale taken from FIG. 10b;

FIG. 11a is a perspective view of a second portion of a mounting fastener separated from a first portion; and

FIG. 11b is a front view of the second portion of the mounting fastener as in FIG. 11a;

FIG. 12a is a perspective view of a first portion of a mounting fastener separated from a second portion;

FIG. 12b is a front view of the first portion of a mounting fastener as in FIG. 12;

FIG. 13a is a perspective view of a timer device according to the present invention;

FIG. 13b is a front view of the time device as in FIG. 13a;

FIG. 14 is a perspective view of a quick load sleeve according to the present invention; and

FIG. 15 is an end view of the quick load sleeve as in FIG. 14.

### DESCRIPTION OF THE PREFERRED EMBODIMENT

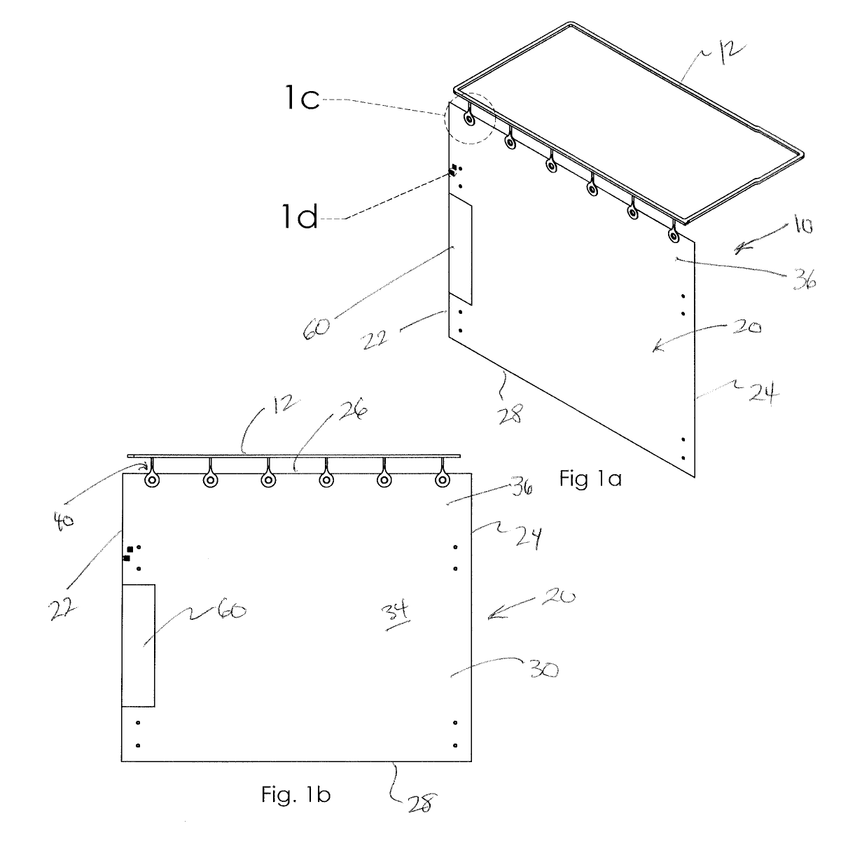

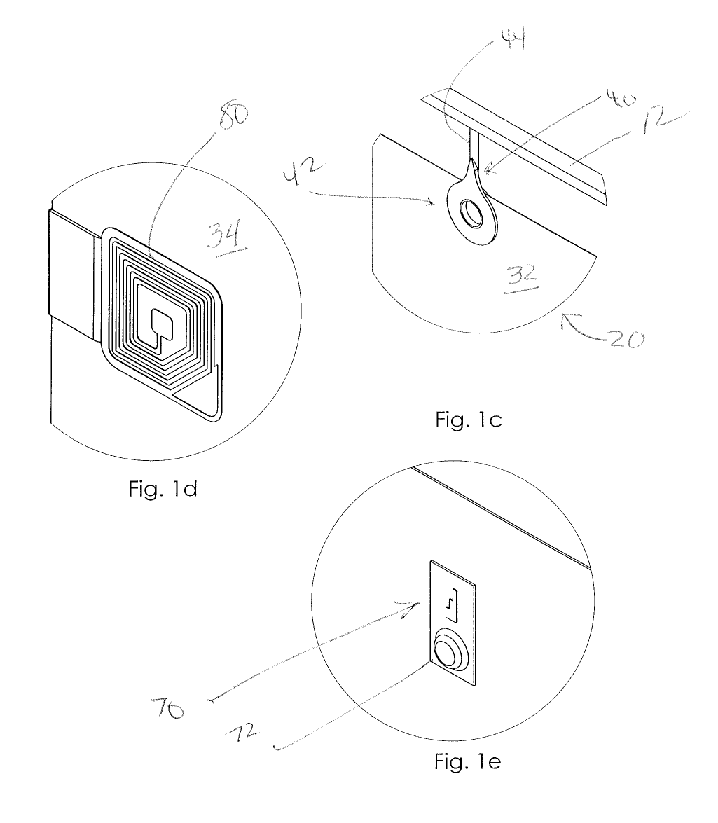

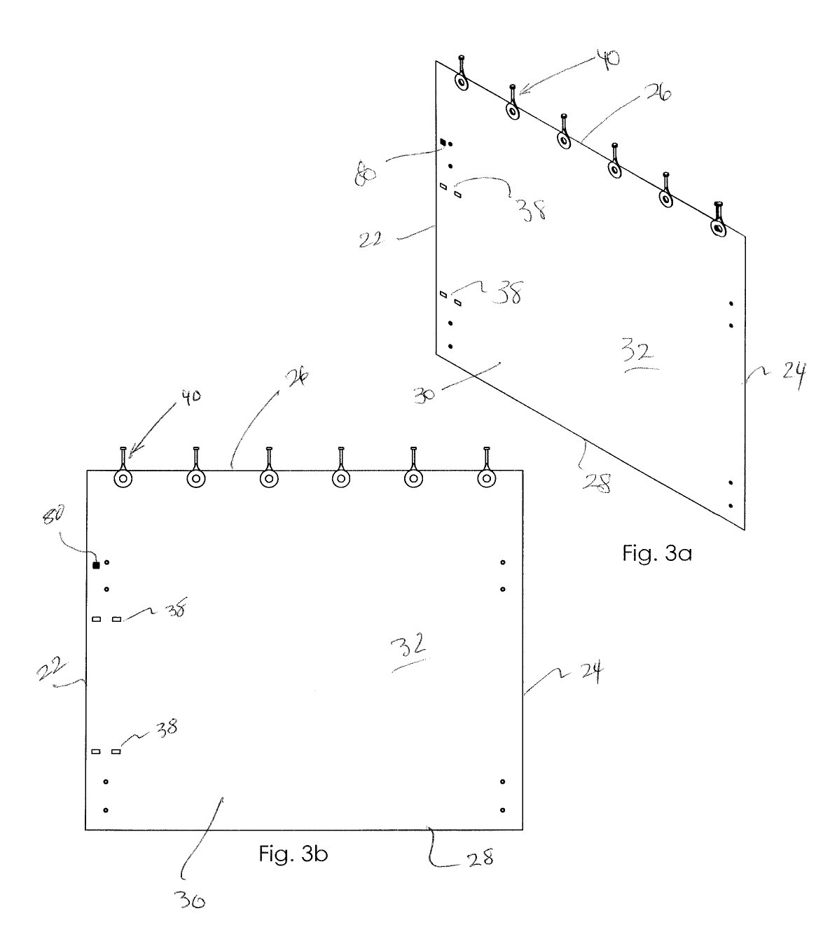

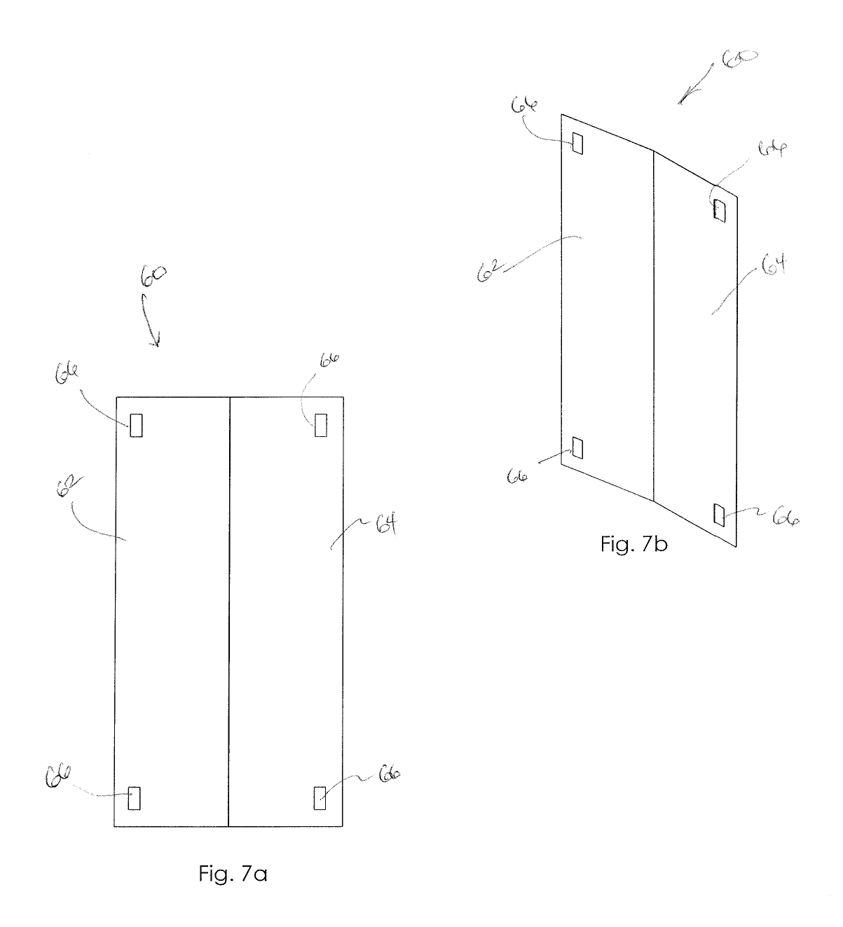

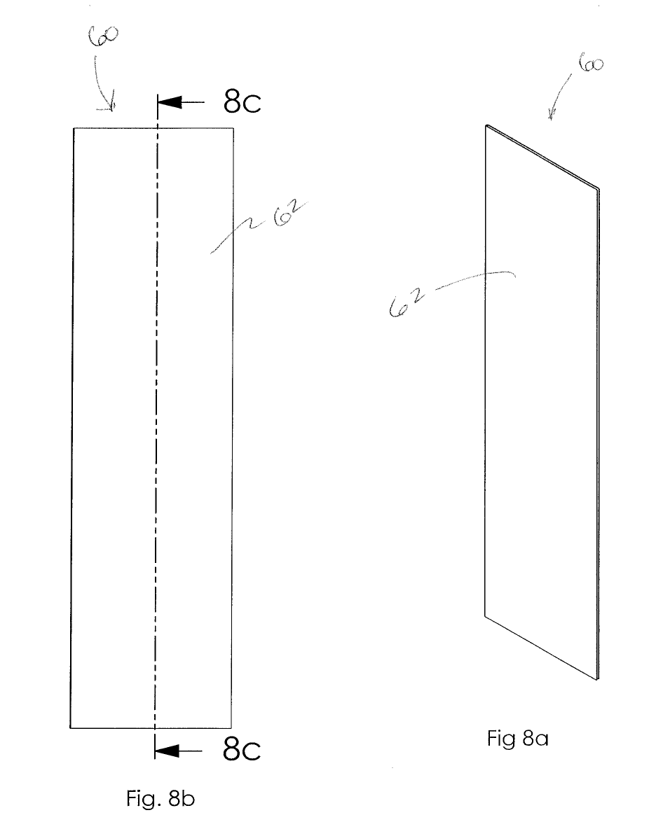

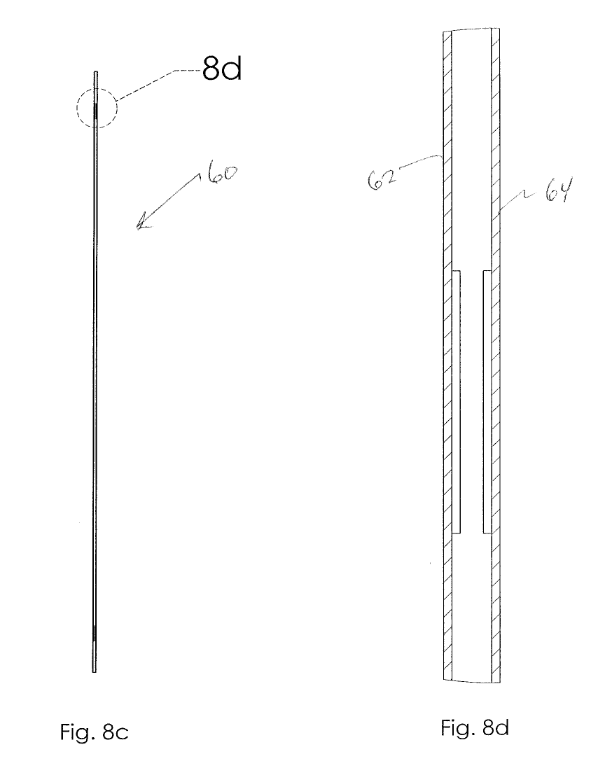

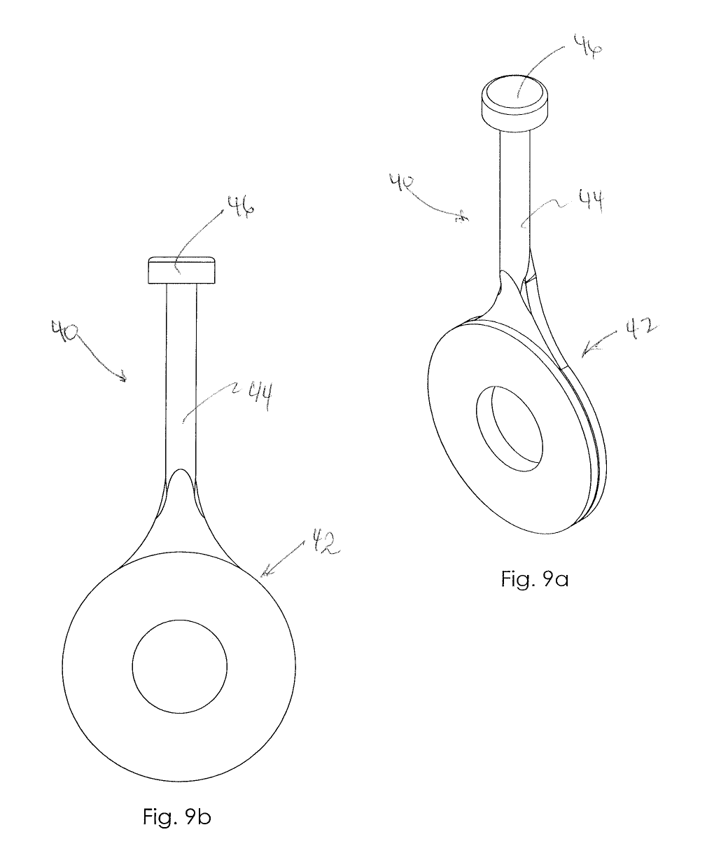

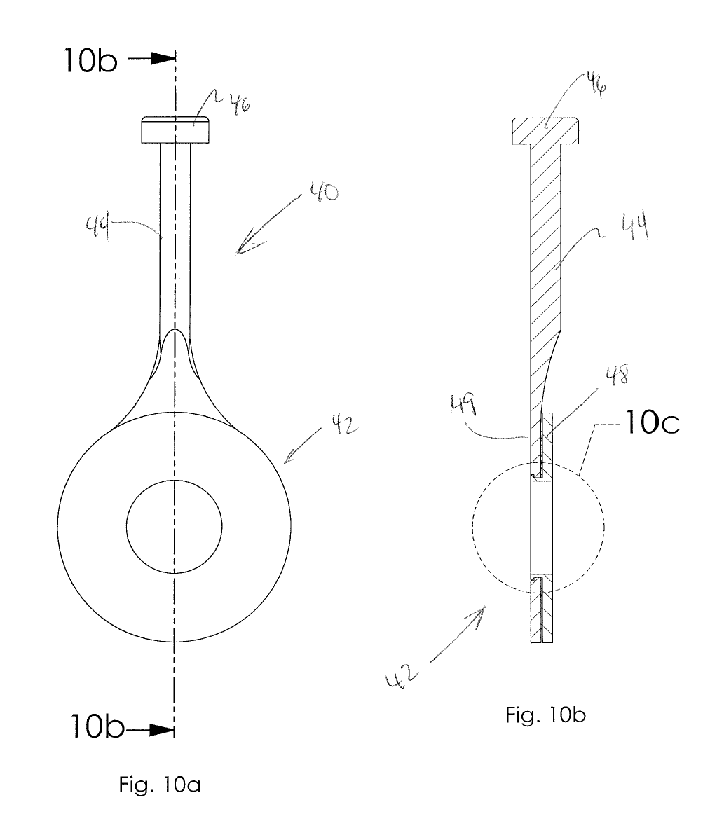

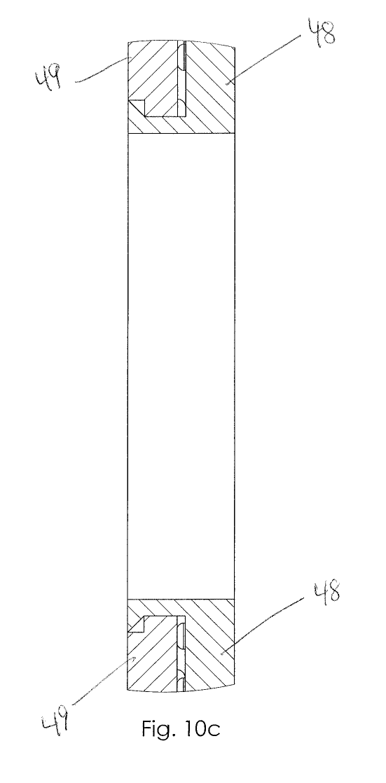

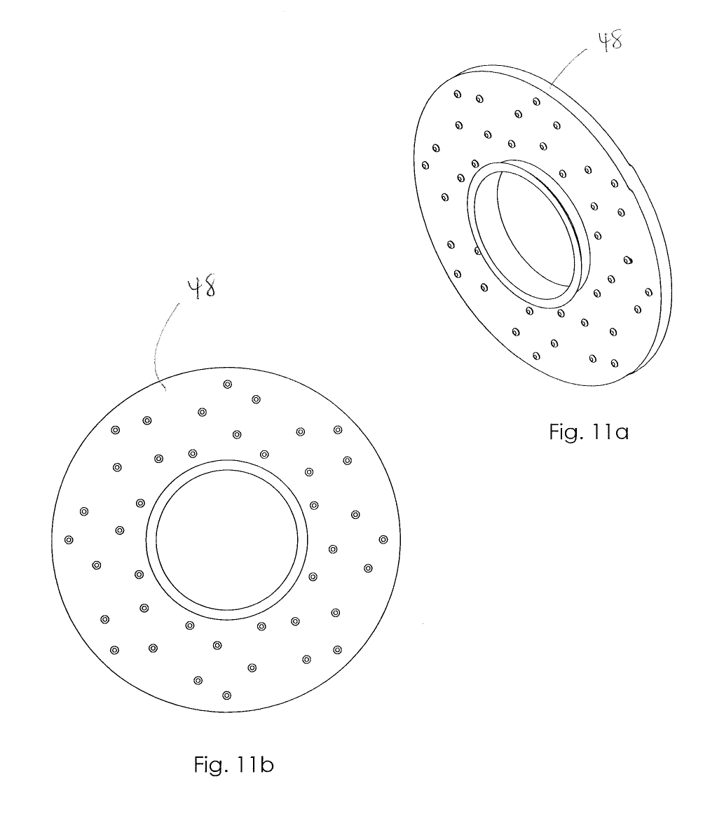

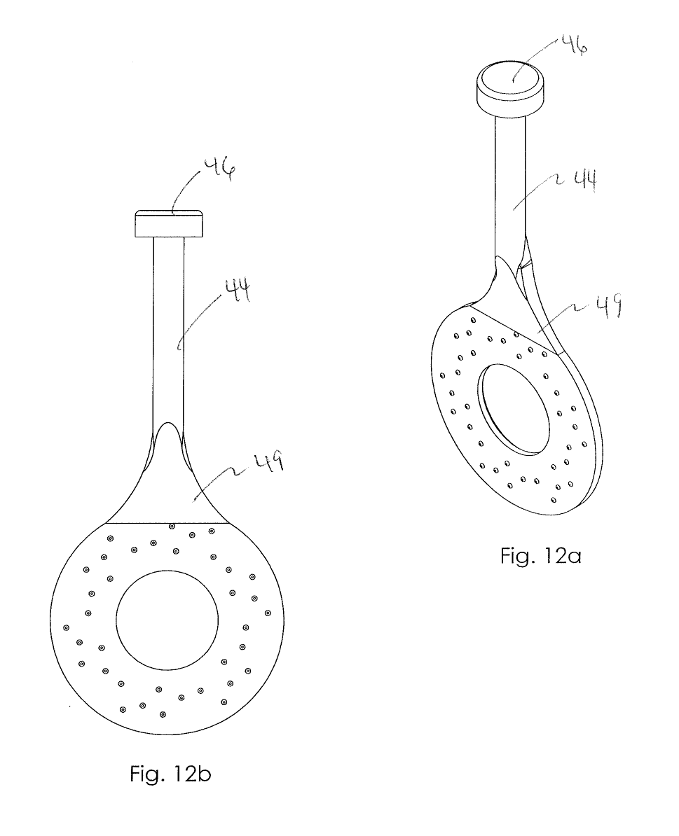

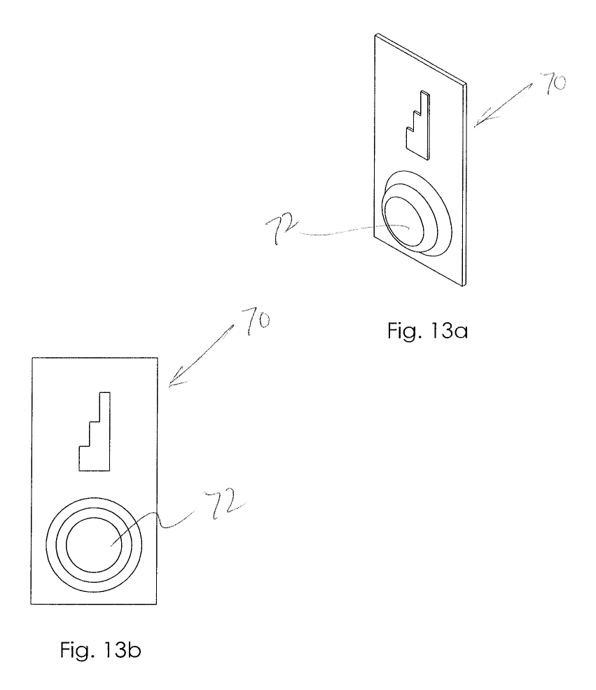

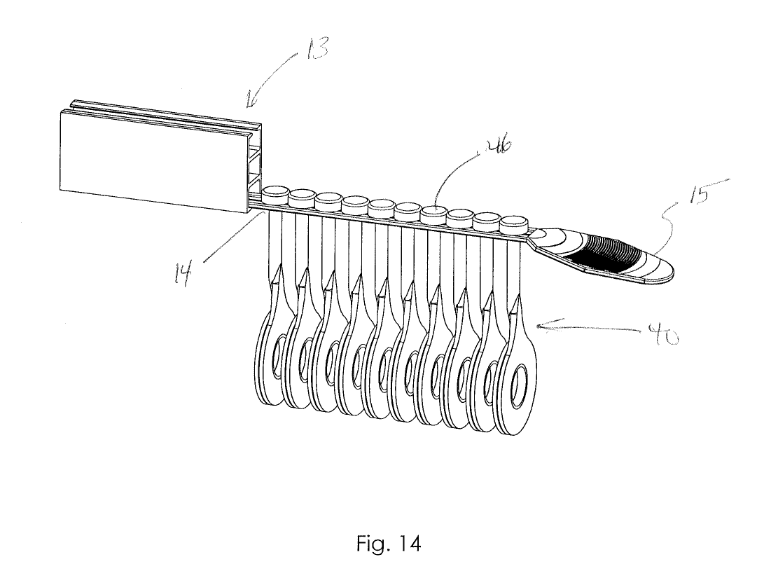

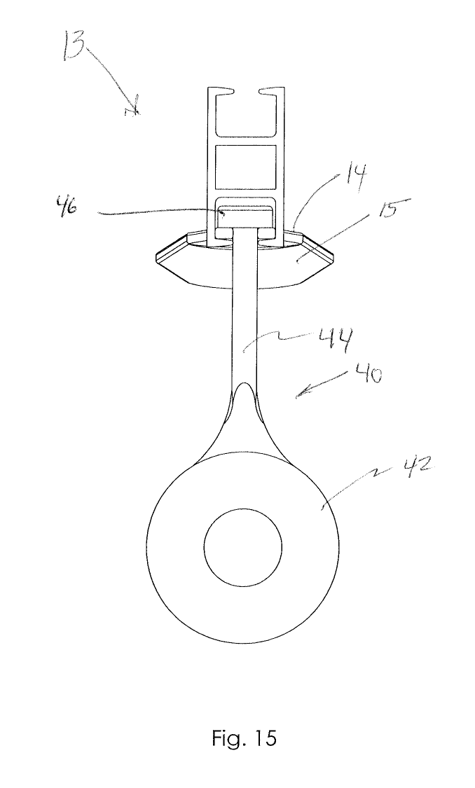

A cubicle privacy curtain assembly according to a preferred embodiment of the present invention will now be described in detail with reference to FIGS. 1 to 15 of the accompanying drawings. The cubicle privacy curtain assembly 10 includes a curtain main portion 20, upstanding track fasteners 40, and a “smart” protective panel 60 removably coupled to a leading edge 22 of the curtain main portion 20.

The curtain main portion 20 includes a series of edges and surfaces that, together, form a sheet or panel that may be coupled to or hung from a medical curtain track 12 that surrounds a predefined space, such as one that surrounds a hospital bed. More particularly, the curtain main portion 20 includes an upstanding leading edge 22 (i.e. at one terminal end of the curtain) and an upstanding trailing edge 24 (i.e. an opposite end of the curtain). The curtain main portion 20 includes a top edge 26 and a bottom edge 28 parallel and opposite the top edge 26 extending between the leading edge 22 and the trailing edge 24, respectively. Again, the edges, collectively, define a curtain sheet 30, the sheet also having front 32 and back 34 sides. The curtain main panel 60 may be divided into a plurality foldable sections in an accordion style or may simply be a planar but flexible sheet of material. Preferably, the curtain main portion is constructed of a fabric, nylon, light plastic, or other similar flexible and durable material.

The curtain main portion 20 may be operatively coupled to the overhead curtain track 12 and configured to move slidably about the curtain track 12, such as to move between open/accessible and closed/inaccessible configurations. More particularly, each track fastener 40 may be coupled at one end to an upper section 36 of the curtain main portion 20 adjacent to the top edge 26 thereof, the track fasteners 40 being spaced apart laterally from one another. Now, more particularly, each track fastener 40 may include a mounting member 42 coupled to the upper section 36 of the curtain main portion 20. In an embodiment, the mounting member 42 is fixedly attached or coupled to the upper section 36 in an integral or secure manner as will be discussed in more detail below.

A respective track fastener 40 includes a rod 44 extending upwardly from the mounting member 42 and extending upwardly of the top edge of the curtain main portion 20. A respective rod 44 extends vertically to a terminal end, referred to herein as a track flange 46 that is configured to be operatively engaged with the curtain track 12. It is understood that the curtain track 12 may engage the track fastener 40 in a tongue and groove engagement so that the respective track fastener 40 is slidable in a channel (not shown) defined by the curtain track 12. Each track fastener may also be referred to as an “integrated glide” which is indicative of being integrated with a top edge of the curtain main panel 60 and enables the curtain main portion 60 to “glide” along the track 12.

In an embodiment, the mounting member 42 may include identical first and second mounting portions that are mirror images of one another and that are mounted so as to sandwich the upper section 36 of the curtain main portion 20 therebetween or otherwise be integrally connected thereto. More particularly, the first mounting portion 48 has an inner surface fixedly attached to one of said the front side or the back side of the curtain sheet 30 proximate the top edge 26. Oppositely, the second mounting portion 49 has an inner surface fixedly attached to another of the front side or the back of said curtain sheet. In other words, the two mounting portions may be situated on opposite sides of the upper section of the curtain main portion 20 in a clamping arrangement. In an embodiment, the mounting portions 48, 49 may have structural configurations that may engage one another in a tight snap-fit engagement. In another embodiment, the inner surfaces of the mounting portions may be coupled to the curtain main portion 20 with adhesive, sewing, or the like.

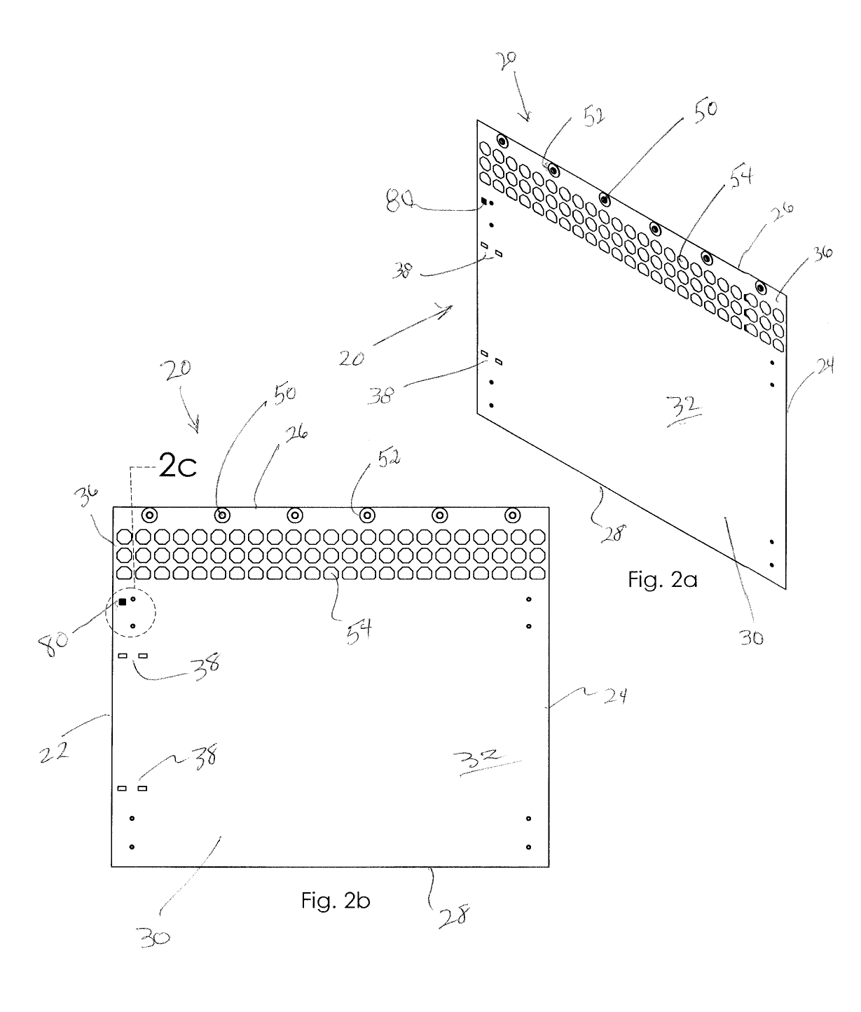

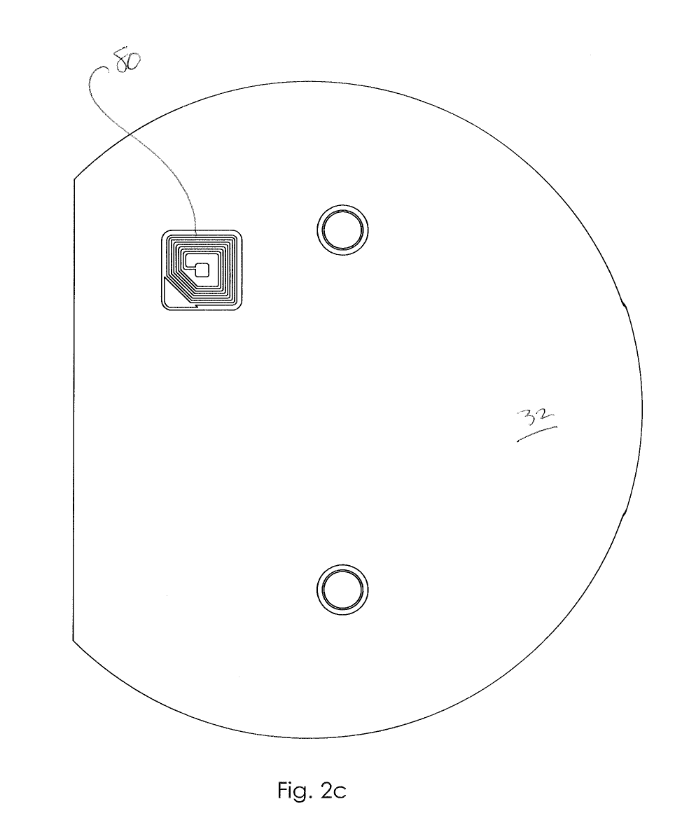

In another embodiment, the upper section of the curtain main portion 20 defines a plurality of spaced apart openings 50, also referred to as eyelets, adjacent the top edge 26 (FIG. 2b). Each opening 50 may be reinforced by a grommet 52 so as to avoid fraying or tearing when the curtain sheet 30 is moved in use. The upper section 36 of the curtain main portion 20 may be constructed of mesh material 54 defining a plurality of open areas that enhance ventilation through the curtain main portion 20.

The curtain assembly 10 includes a protective panel 60 removably coupled to the curtain main portion 20 along the leading edge 22. Preferably, the protective panel 60 has a generally rectangular configuration and is positioned midway between the top edge 26 and bottom edge 28 of the curtain main portion 20 (FIG. 1a) although other shape configurations and positions along the leading edge 22 would also work. Preferably, the protective panel 60 is constructed of a Polypropylene (PP) non-woven material.

The protective panel 60 includes a front section 62 and a rear section 64 connected to the front section in a unitary construction, the protective panel 60 defining a line of weakness or crease at the junction been front and rear sections so that the front section is foldable toward the rear section. In other words, the line of weakness or crease is at the center of the panel so that the two sections divided thereby may be folded onto one another. In practice, however, the sections are not folded on each other but rather onto the curtain main portion 20 with the leading edge 22 nested in the line of weakness, as shown in the drawings.

The protective panel 60 is removably coupled to the curtain main portion 20 with strategically placed fasteners. More particularly, the front side 32 of the curtain main portion 20 may include at least one of a hook and loop fastener 38 positioned proximate the leading edge 22. Then, a rear surface of the front section 62 of the protective panel 60 may include another of a hook and loop fastener 66 appropriately positioned such that the front section 62 is selectively and removably coupled to the front side 32 of the curtain main portion 20 in a hook and loop engagement of complementary fasteners as was just described.

Similarly, the back side 34 of the curtain main portion 20 may include at least one of a hook and loop fastener 38 positioned proximate the leading edge 22. Then, a rear surface of the rear section 64 of the protective panel 60 may include another of a hook and loop fastener 66 appropriately positioned such that the rear section 64 is selectively and removably coupled to the back side 34 of the curtain main portion 20 in a hook and loop engagement of complementary fasteners as was just described. It is understood that other types of fasteners may be used to coupled a protective panel 60 to the sides of the curtain main portion 20, such as clasps, adhesive, buttons, snaps, and the like.

In another aspect, a timer device 70 is coupled to the protective panel 60 and configured to indicate when the protective panel 60 needs to be removed from the curtain main portion 20 and replaced with a new one. Specifically, the timer device 70 may include a reservoir containing dye that may be pressure activated, such as by a user applying pressure to an activation button 72 with a finger. The dye is formulated to change color over a predetermined period of time so as to indicate expiration of a predetermined amount of time. For instance, the dye may initially have a blue color but, in time, exhibit a red color indicating it is time to replace the protective panel 60, e.g. by separating the fasteners as described above and removing the panel. By detecting and indicating when the protective panel 60 is ready or “due” to be replaced, the panel may be referred to as a “smart” protective panel 60.

In a related aspect, an automated data collection member 80 may be coupled to a front side of the curtain sheet 30 formed by the curtain main portion 20. More particularly, the data collection member 80 includes encoded data that specifically identifies the unique identification of the curtain main portion 20. The data collection member 80 may identify the curtain main portion 20 by way of a specific number or code that may correspond to a matching identifier in a remote database having customer defined protocol records. For instance, a hospital may have a computer database (not shown) that keeps track of what curtains are deployed in respective hospital rooms, records of when respective protective panels have been replaced, and the overall rules or procedures regarding replacement timing or the like. Together, this data is referred to as “protocol data” or simply as “the Protocol.”

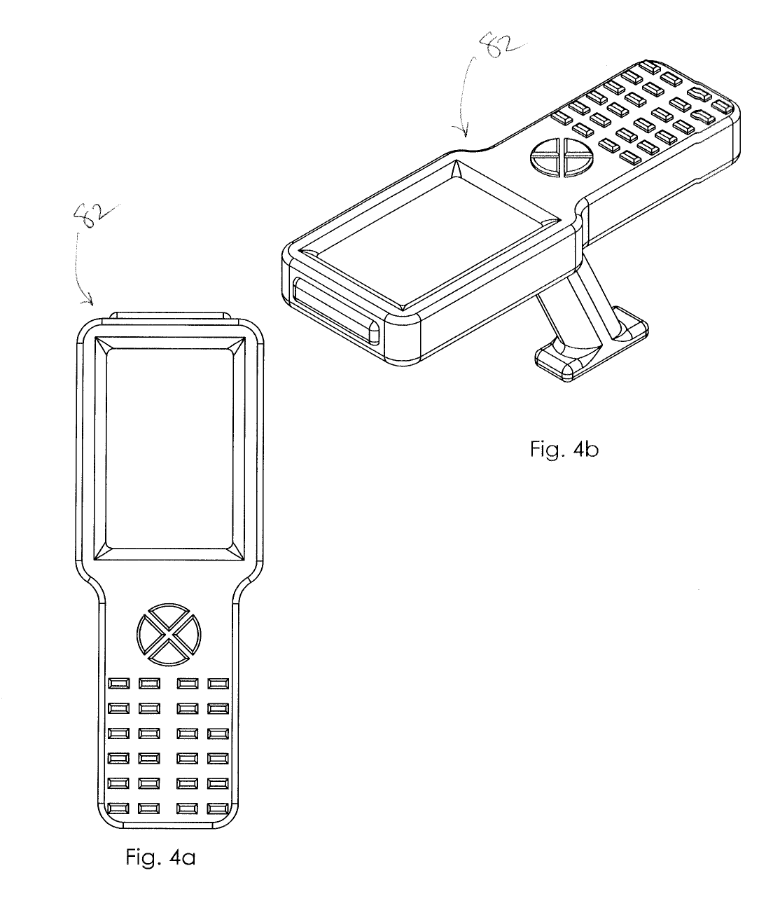

The data collection member 80 may be a radio frequency identification device (“RFID”), a bar code, a QR code, or the like, that may be scanned by a respective reading device. For instance, a RFID tag may be coupled to the curtain main portion 20 and its stored data may be read by a respective RFID reading device 82 (FIG. 4b). It is understood that the reading device 82 may be real time communication with the remote customer protocol management database or may store data within an internal memory and uploaded to the remote customer protocol database at a later time. The RFID reading device 82 may include a display screen and input buttons to enable a nurse or technician to identify the unique curtain identifier, to correlate a room number with the curtain identifier, to record data identifying a time and identifier regarding replacement of a protective panel 60, or the like.

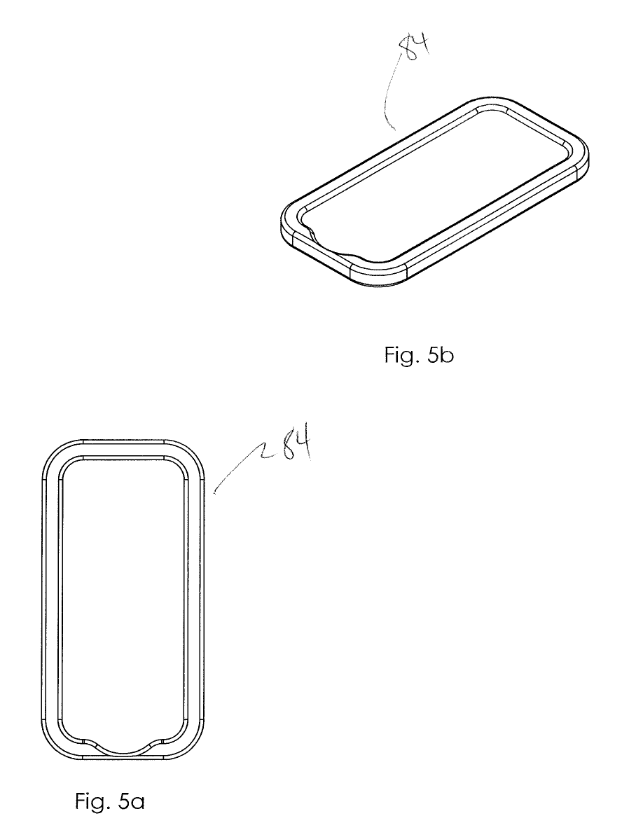

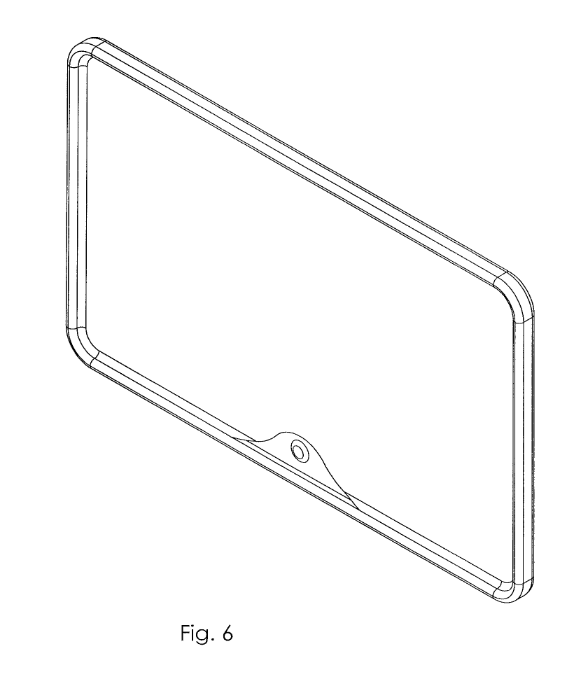

Alternatively, the data reading device may be implemented as a software application running on a mobile computing device such as a cell phone, e.g. a smart phone 84 (FIG. 5a) or a tablet (FIG. 6). The smart phone 84 may include a camera programmed to selectively “read” the code of the data collection device 80. In other words, the camera of the smart phone is the data reading device. The software application, then, may be programmed to associate the code with the curtain identifier, to receive input from a user indicative of a room number, a date and protective panel 60 identifier, or the like in the substantially the same manner described above.

In an embodiment, a “quick load sleeve” 13 may be mounted in communication with the channel of the overhead curtain track 12. The quick load sleeve 13 defines a loading track 14 configured to receive a plurality of terminal ends of respective track fasteners 40 (“integrated glides”) therein (FIG. 14), such as in a tongue and groove combination described above. The quick load sleeve 13 enables the track fasteners 40 associated with an entire curtain assembly 10 to be “preloaded” in a tightly adjacent grouping. For instance, a curtain track 12 can always be ready to deploy a curtain assembly ## such as when a room is being prepared for a new patient. It is understood that a preloaded sleeve 13 may be positioned in communication with the overhead curtain track 12 when needed to deploy a new curtain panel and then removed when deployed or may become a permanent fixture coupled to the curtain track 12.

More particularly, the quick load sleeve 13 may include an end cap 15 pivotally movable at a distal end of the quick load track 14. The end cap 15 may be moved between an open configuration that enables respective terminal ends of respective track fasteners 40 to be slidably loaded into the quick load track 14 and a closed configuration blocking such loading. Once loaded and staff is ready to deploy a curtain assembly 10, the respective track fasteners 40 may be quickly and slidably deployed along the main track 12. It is understood that considerable time may be saved by deploying a pre-loaded sleeve rather than the traditional method of having to hang each fastener individually to the curtain track and then deploy evenly. Once loaded and/or deployed, of course, the end cap 15 may be returned to the closed configuration so that respective track fasteners 40 cannot be inadvertently reversed off the curtain track 12 and quick load sleeve 13.

In use, a plurality of patient rooms in a hospital environment may be outfitted with a standard overhead curtain track 12. Then, a curtain assembly 10 may be mounted to the track 12 in the manner(s) described above. The curtain main portion 20 is then situated to move slidably along the track 12 to selectively grant access into the private area defined by the curtain. Advantageously, the protective panel 60 mounted along the leading edge 22 of the curtain main portion 20 may be grasped by staff, visitors, and even the patient when sliding the curtain—thus receiving the significant portion of dirt, germs, bacteria, and the like rather than the curtain proper.

In specific embodiments, the timer device 70 coupled to the protective panel 60 may be pressure activated to begin tracking an amount of time since the protective panel 60 has been replaced. When this timer device 70 reaches a specific visual condition, hospital staff is made aware that the protective panel 60 may be removed from the curtain main portion 20 as described above and a new one mounted in its place. Preferably, this replacement protocol is done in coordination with electronically reading the data collection member 80 as described above so that the inventory management database may be updated. Therefore, the database may be accessed by hospital staff and administrators to accurately assess quality control data, inventory and ordering data, and overall efficiency and safety protocols.

It is understood that while certain forms of this invention have been illustrated and described, it is not limited thereto except insofar as such limitations are included in the following claims and allowable functional equivalents thereof.

1. A cubicle privacy curtain assembly configured for selective connection to an overhead curtain track that defines a predefined area, said curtain assembly including:
a curtain main portion having an upstanding leading edge and a trailing edge opposed from said leading edge, said curtain main portion having opposed top and bottom edges extending between said leading and trailing edges, respectively, such that said edges collectively define a flexible curtain sheet having front and back sides;
a flexible protective panel removably coupled by at least two magnets to said curtain main portion along said leading edge, said protective panel having a front section and a rear section connected to the front section in a unitary construction, said front section being selectively foldable toward said rear section along an upstanding center line of weakness such that said front and rear sections of said protective panel are selectively positioned on said front and back sides of said curtain sheet, respectively, with said leading edge in contact with said center line of weakness; and
a timer device coupled to said protective panel, said timer device including pressure activated dye configured to change color at a predetermined rate over a predetermined period of time to indicate when a respective protective panel should be replaced as a function of time.

2. The curtain assembly as in claim 1, wherein:
said front side of said curtain main portion includes at least one of a hook and loop fastener positioned proximate said leading edge;
a rear surface of said front section of said protective panel includes another of a hook and loop fastener such that said front section is selectively coupled to said front side of said curtain main portion in a hook and loop engagement of complementary fasteners;
a said back side of said curtain main portion includes at least one of a hook and loop fastener;
a tear surface of said rear section of said protective panel includes another of a hook and loop fastener such that said rear section is selectively coupled to said back side of said curtain main portion in a hook and loop engagement of complementary fasteners.

3. The curtain assembly as in claim 1, further comprising a plurality of track fasteners coupled to an upper section of said curtain main portion and spaced apart from one another, each track fastener having a mounting member integrally attached to said upper section and having a rod extending upwardly from said mounting portion to a track flange configured to operatively engage with the curtain track;
wherein said mounting member of respective track fasteners includes:
a first mounting portion having an inner surface fixedly attached to one of said front surface or said back side of said curtain sheet;
a second mounting portion having an inner surface fixedly attached to another of said front side or said back sides of said curtain sheet;
whereby said upper section of said curtain main portion is sandwiched between said first and second mounting portions in a clamping arrangement.

4. The curtain assembly as in claim 3, wherein said inner surfaces of said inner and outer portion, respectively, are coupled together in e snap-fit engagement.

5. (canceled)

6. The curtain assembly as in claim 1, wherein said upper section of said curtain main portion is constructed of a mesh material defining a plurality of openings for ventilation of the curtain main portion.

7. (canceled)

8. The curtain assembly as in claim 1, further comprising:
an automated data collection member coupled to said front side of said curtain sheet, said automated data collection member including encoded data indicative of an identification of said protective panel;
wherein said automated data collection member is associated with a data reading device configured to collect said encoded data from said data collection member when said data reading device is within a predetermined proximity to said data collection member.

9. The curtain assembly as in claim 8, herein said data collection member is taken from a group consisting of a barcode, a QR code, and a radio frequency identification tag.

10. The curtain assembly as in claim 8, further comprising:
a software application running on a mobile computing device having a processor, a memory, a camera, an input, and a display, said application including a database having a plurality of curtain protocol records; and
wherein said software application is in data communication with said data reading device and configured such that said encoded data is received and processed by said application after being collected thereby.

11. A cubicle privacy curtain assembly for selective connection to an overhead curtain track that defines a predefined area, said curtain assembly including:
a curtain main portion having an upstanding leading edge and a trailing edge opposed from said leading edge, said curtain main portion having opposed top and bottom edges extending between said leading and trailing edges, respectively, such that said edges collectively define a flexible curtain sheet having front and back sides;
wherein said top edge of said curtain main portion is selectively coupled to the curtain track;
a flexible protective panel removably coupled to said curtain main portion along said leading edge by a pair of magnets, said protective panel having a front section and a rear section connected to the front section in a unitary construction, said front section being selectively foldable toward said rear section along an upstanding center line of weakness such that said front and rear sections of said protective panel are selectively positioned on said front and back sides of said curtain sheet, respectively, with said leading edge in contact with said center line of weakness; and
an automated data collection member coupled to said front side of said curtain sheet, said automated data collection member including encoded data indicative of a unique identifier associated with said protective panel;
a database having at least one curtain protocol record associated with said protective panel, wherein said protocol record includes data indicative of when said protective panel was last replaced and data indicative of rules and procedures related to replacement and timing of said replacement.

12. The curtain assembly as in claim 11, wherein said data collection member is associated with a data reading device configured to collect said encoded data from said data collection member when said data reading device is within a predetermined proximity to said data collection member.

13. The curtain assembly as in claim 12, wherein said data collection member is taken from a group consisting of a barcode, a QR code, and a radio frequency identification tag.

14. The curtain assembly as in claim 12, further comprising:
a software application running on a mobile computing device having a processor, a memory, a camera, an input, and a display, said application in data communication with said database having a plurality of curtain protocol records; and
wherein said software application is in data communication with said data reading device such that said encoded data is received and processed by said application after being collected thereby.

15. The curtain assembly as in claim 11, wherein:
said front side of said curtain main portion includes at least one of a hook and loop fastener positioned proximate said leading edge; and
a rear surface of said front section of said protective panel includes another of a hook and loop fastener such that said first section is selectively coupled to said front side of said curtain main portion in a hook and loop engagement of complementary fasteners;
said back side of said curtain main portion includes at least one of a hook and loop fastener; and
a rear surface of said rear section of said protective panel includes another of a hook and loop fastener such that said second section is selectively coupled to said front side of said curtain main portion in a hook and loop engagement of complementary fasteners.

16. The curtain assembly as in claim 11, wherein:
said upper section of said curtain main portion is constructed of a mesh material defining a plurality of openings for ventilation of the predefined area;
said upper section defines a plurality of eyelets intermediate said mesh material and said top edge that are configured to couple said certain main portion to the curtain track with a plurality of mounting fasteners, respectively.

17. The curtain assembly as in claim 11, further comprising a timer device coupled to said protective panel, said timer device including pressure activated dye configured to change color at a predetermined rate over a predetermined period of time as a indicator of when a respective protective panel should be replaced as a function of time.

18. (canceled)

19. The curtain assembly as in claim 11, further comprising a plurality of track fasteners coupled adjacent said top edge said of said curtain main portion and spaced apart from one another, each track fastener having a mounting member integrally attached to said upper section and having a rod extending upwardly from said mounting portion to a track flange configured to operatively engage with the curtain track.

20. (canceled)

21. The curtain assembly as in claim 1, wherein the timer device further comprises an activation button to initiate the predetermined period of time.
